(19) United States
(12) Patent Application Publication
(10) Pub. No.: US 2007/0202236 A1
(43) Pub. Date: Aug. 30, 2007

(54) Flavored cheese slices and methods for flavoring cheese

(75) Inventors: John Kieran Brody, Plymouth, WI (US); Kim M. DeSmidt, Plymouth, WI (US); Nancy M. Krahn, Glenbeulah, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(73) Assignee: Sargento Foods, Inc.

(21) Appl. No.: 11/363,823

(22) Filed: Feb. 28, 2006

(51) Int. Cl. A23C 19/00

(52) U.S. Cl. 426/582

(57) ABSTRACT

A sliced, flavored cheese product and methods of flavoring cheese is disclosed in which individual slices of cheese are separated by an interleaf paper barrier that includes a flavoring component, such as smoke flavor, applied to at least one of the two surfaces thereof. By placing each cheese slice in contact with the flavored interleaf paper, and packaging the cheese slices in a conventional manner, the cheese slices therein are imparted with the flavoring component, thereby providing a flavored cheese slice. A variety of different types of cheeses can be flavored with the methods of flavoring cheese of the present invention.

### BACKGROUND OF THE INVENTION

### Field of the Invention

The present invention relates generally to cheese, and more particularly to smoked and/or flavored cheese slices and methods for flavoring cheese using a flavored interleaf paper or barrier material.

Traditionally, natural cheeses, including, soft, semi-hard or hard natural cheese, are formed into larger wheels and/or blocks during curing and/or production thereof. However, due to its convenience, the popularity of cheeses in smaller consumer-ready forms, sizes and quantities, such as shredded cheese, chunks, and/or cheese slices, is rapidly growing.

In particular, consumers like the convenience of cheese slices coupled with the taste and appeal of deli-style cheeses. Typically, pre-cut cheese slices include an interleaf sheet of paper between each slice, allowing a user to quickly and easily obtain a single slice of cheese without damaging any remaining slices of cheese in the stack. In the commercial environment, the availability of pre-cut cheese slices permits easy dispensation of the cheese at selected weights and sizes, for consistency in such applications. In addition, pre-sliced cheeses eliminate the need for slicers in deli and retail applications, thereby reducing accidents and the risk of food-borne illnesses.

In addition to convenience, the sophistication of consumers as to the types and flavors of cheese is changing. In particular, consumers look for unique types of cheeses, flavors and/or specialty cheeses for pairings with meals, wines and desserts. Indeed, as consumers become more educated about cheese, they seek out cheese options other than traditional types and flavors of cheese. In turn, cheesemaking has become increasingly more sophisticated, with makers incorporating seasonings, or other ingredients into the cheese curd to create specialty artisan cheeses.

Smoked cheese is one type of flavored cheese that is popular in cheddar, gouda, provolone, mozzarella and/or other hard, semi-soft and soft cheese varieties. Smoked cheese has a characteristic appearance, aroma, and taste, based largely on the type of smoke wood used and the amount of smoke applied.

Traditional smoking methods to smoke bulk cheese require that the cheese be unpackaged, transported to and placed in a smoke room for a given period to time—which can range from a period of hours to days. The cheese is then cooled and repackaged prior to being cut, shredded and/or sliced for consumer use. Because the trim cheese remaining after the bulk cheese is cut, shredded and/or sliced already has a smoke flavor, it is often sold at very low prices and it is substantially limited in its resale applications and value.

It is accordingly the primary objective of the present invention that it provide one or more smoked cheese products, wherein natural cheese slices are flavored, within the consumer package using an interleaf paper or barrier material having smoke flavoring applied to one or more surfaces thereof. Further, the present invention provides a smoke flavored cheese product that is imparted smoked cheese coloring, similar to that of traditionally smoked cheeses.

In addition, the present invention provides a smoked, natural cheese product that is imparted with a smoke flavoring after trimming and slicing of the bulk cheese product, rendering the trim cheese unflavored/unsmoked and more valuable for resale. The present invention also provides a variety of smoked cheese products and a method of imparting a smoke flavor to a sliced cheese product that does not require the time, expense and labor of traditional smoking methods.

Accordingly, it is another object of the present invention to provide a flavored cheese product, provided in convenient individual slices, separated by a flavor-coated interleaf paper, wherein the interleaf paper is used not only for flavoring the cheese within the consumer package but also for facilitating removal of the cheese from the package or stack of cheese after purchase. It is a related objective of the present invention that it contemplate a variety of different types of flavored cheese slices, including different cheeses, or combinations of cheeses, different flavoring components and/or combinations of flavoring components.

As such, it is another objective of the present invention to provide one or more methods of flavoring a cheese product including separating each cheese slice in a stack of cheese slices with an interleaf paper or barrier material coated with at least one flavoring component, such that at least one of the surfaces of each slice of cheese is in contact with the flavoring component, and packaging the cheese slices in a conventional manner. As such, the cheese slices disposed with the package are imparted with the flavor disposed on the interleaf paper, thereby providing a flavored cheese slice.

The flavored cheese slices of the present invention must also be of high quality and must also remain fresh both before and after the packaging is opened, and they should also require little other than refrigeration to keep them fresh over an extended time period. In order to enhance the market appeal of the flavored cheese slices, in particular smoked cheese slices, of the present invention, they should also be of comparable cost to conventional flavored or smoked cheeses to thereby afford them the broadest possible market. Finally, it is also an objective that all of the aforesaid advantages and objectives of the flavored cheese slices of the present invention be achieved without incurring any substantial relative disadvantage.

### SUMMARY OF THE INVENTION

The disadvantages and limitations of the background art discussed above are overcome by the present invention. With this invention, a smoked and/or flavored sliced cheese product is produced wherein a sheet of interleaf material treated with a smoke and/or flavoring component is interposed between individual slices of cheese in a stack of cheese slices, with the flavored sliced cheese product then being packaged in a conventional manner.

The type of cheese used in the present invention is preferably a natural cheese, such as cheddar or mozzarella. However, any variety of soft, semi-hard or hard natural cheeses can be used with good effect. For example, provolone, Swiss, Monterrey Jack, Asiago, Colby, blue, and Colby-Jack cheeses can all be sliced and used as the base for the flavored cheese slices and methods of the present invention. In addition, processed, low cholesterol, imitation cheeses and vegan cheeses can also be used as the base for the flavored cheese product of the present invention, so the term “cheese” as used herein should be broadly interpreted to include any one or more of such products. In particular, the present invention is applicable to cheeses having a variety of different fat and moisture contents, textures, etc., depending on desired consumer or market demands.

The selected cheese can be sliced by any method known to those skilled in the art and is preferably sliced into any of a variety of standard commercial or retail sizes. Importantly, and as will be appreciated by those skilled in the art, the cheese is sliced or cut prior to flavoring, leaving the “trim” cheese or remaining cheese unflavored, and therefore, easily utilized in other applications, such as in processed cheese or as an ingredient in another food product.

Preferably, each slice of cheese is about three and one-half inches by about three and one-half inches, having a thickness of about one-sixteenth of an inch. However, each of the slices be up to about twelve inches in length and up to about six inches in width, depending on the type of cheese to be flavored and/or the specific end-use product (i.e. consumer vs. commercial retail). The cheese slices can be any shape, such as rectangular, oval or circular, depending on the type of cheese selected or desired end-use packaging or food application.

In addition, the thickness of each cheese slice can range from about one-thirty-second of an inch to about one-eighth of an inch, however, slices having a smaller or larger thickness are also contemplated by the present invention. Similarly, where the particular application requires a particular cheese weight, any of the dimensions of the cheese slice may be altered to accommodate such weight requirement. Further, as will be recognized by those skilled in the art, the size and thickness of the cheese slice may be any of those available using conventional slicing equipment.

The interleaf material using in the present invention is preferably constructed of paper or another cellulose-based material, as will be well known to those skilled in the art. Further, any material known to those skilled the art that is considered safe or traditionally used for direct food contact applications and/or approved for use in direct food contact applications by the Food and Drug Administration (FDA), such as thermoplastic films, foil, etc. can be used with good effect.

The interleaf paper is to be slightly larger than the size of the cheese slice, such that the entire surface of the cheese slice is in contact with the interleaf paper. For example, if the cheese slices are about three and one-half inches by about three and one-half inches in dimension, the sheet of interleaf paper can be about four inches by about four inches.

As will be appreciated by those skilled in the art, the interleaf paper can be of any size and shape; and preferably sized to correspond with the size and shape of each slice of cheese, whereby each sheet is slightly larger than each slice of cheese. Further, the sheet of interleaf paper may be of different sizes, where required, for example, the bottom sheet or the top sheet in a consumer package may be larger than the remaining sheets.

Preferably, the top surface of each sheet of interleaf paper is coated with a flavoring component. However, where required by the given manufacturing, and/or packaging requirements, the type of flavoring component, the desired flavor intensity to be imparted to the cheese and the type of cheese, the bottom surface or both the top surface and the bottom surface may be treated and/or coated with a flavoring component.

The flavoring component is preferably a smoke flavor; however, the flavor can be any of those known to those skilled in the art, including, but not limited to, garlic, onion, chives, spices, herbs, such as dill, oregano, mint, parsley or basil, barbeque, bacon, alcohol (brandy, wine, etc.), fruit, such as strawberry or blueberry, vegetable flavors, such as tomato, mushroom or pepper, and/or flavors, such as vanilla, bubblegum and/or chocolate, with imagination being the only limitation. As will also be readily apparent, a combination of flavoring components may also be used.

The flavoring component is applied to the interleaf paper by spraying, painting, rolling or otherwise treating the interleaf paper with the flavoring component on to the desired surface(s) thereof in any manner known to those skilled in the art for coating such interleaf paper or interleaf material.

The thickness of the flavoring component, and/or the concentration of the flavoring component applied to the interleaf paper will depend on the specific composition and physical properties of the flavoring component, the intensity of the flavor desired to be imparted to the cheese, the type of cheese, the fat content of the cheese and/or the thickness of the cheese slices. For example, the thickness of flavoring component can be larger, and/or more concentrated if a thicker cheese slice is to be flavored by the method of the present invention.

The flavoring component is preferably allowed to dry prior to mating the interleaf paper with the cheese slices. As will be well known to those skilled in the art, the interleaf paper can be provided with the desired flavoring component before or after being cut into individual sheets, as required by a given production line and/or operational equipment.

To produce the flavored cheese slices of the present invention, a roll of coated interleaf paper and/or pre-cut sheets thereof are supplied to the conventional slicing and/or packaging operation. Individual cheese slices are mated with individual sheets of flavored interleaf paper forming a stack of cheese slices comprising a plurality of cheese slices, with each slice separated by a sheet of flavored interleaf paper.

The stack of cheese slices is preferably assembled with a bottom sheet of interleaf paper having a flavoring component applied to the top surface thereof and a cheese slice placed directly overlying the cheese slice. To ensure uniform flavoring of the cheese slice, the entire surface area of the bottom surface of the slice contacts the flavoring component applied to the top surface of the interleaf paper. Accordingly, assembly of the stack continues by alternating a sheet of interleaf paper with a cheese slice such that each slice of cheese is separated by a sheet of interleaf paper in the manner described above. Assembly of the stack of cheese slices continues until the stack of cheese slices contains the desired number of cheese slices.

The stack of cheese slices is enclosed within a convention consumer package, or otherwise overwrapped with a plastic film, as will be well known to those skilled in the art. The package can be constructed of a thermoplastic film material, having the physical properties (i.e. porosity, permeability and composition) appropriate for storing and retailing cheese slices of the particular selected variety—as will be well known to those skilled in the art of cheese packaging.

The package of cheese slices is stored at a temperature and humidity level appropriate for the particular cheese to be flavored by the methods of the present invention, as will be well known by those skilled in the art and/or determined by application food safety and storing requirements.

After packaging, the stack of cheese may be stored (or alternatively begun its transportation to a retail destination) with flavoring of the cheese slices occurring in the consumer package. As such, during storage or transportation of the packages of the cheese slices, the flavoring component disposed on the surface of the interleaf paper is absorbed by or otherwise imparted to the cheese.

Storage can continue until the desired flavor intensity is imparted to the cheese slices; however, typically the desired and final flavor intensity is imparted to the cheese slice in one day, with the flavor intensifying over a period of about two weeks. Of course, such time will depend on the type, size and composition of the cheese slice, and the type, composition and thickness of the flavoring component provided on the interleaf paper in contact therewith. Importantly, and given the perishable nature of natural cheeses, the flavoring component applied to the interleaf paper is provided in an amount sufficient to impart the desired flavor intensity to the cheese over a reasonable period of storing and/or curing time and in a manner in which the flavor and/or intensity of flavor of the cheese slices is does not change and/or the flavor does not substantially change after retail and/or purchase of the cheese product.

It may therefore be seen that the present invention teaches one or more smoked cheese products, wherein cheese slices are flavored, within the consumer package using an interleaf paper or barrier material having smoke flavoring applied to one or more surfaces thereof. In particular, the present invention provides a smoked cheese product that is imparted with a smoke flavoring after trimming and slicing of the bulk cheese product, rendering the trim cheese unflavored/unsmoked and more valuable for resale. The present invention also provides a variety of smoked cheese products having the taste, appearance and aroma of cheese smoked by traditional methods and a method of imparting a smoke flavor to cheese slices that does not require the time, expense and labor of traditional smoking methods.

The present invention also teaches a flavored cheese product, provided in convenient individual slices, separated by a flavor-coated interleaf paper, wherein the interleaf paper is used not only for flavoring the cheese within the consumer package but also for facilitating removal of the cheese from the package or stack of cheese after purchase.

As such, the present invention also teaches one or more methods of flavoring a cheese product including separating each cheese slice in a stack of cheese slices with an interleaf paper or barrier material coated with at least one flavoring component, such that at least one of the surfaces of each slice of cheese is in contact with the flavoring component, and packaging the cheese slices in a conventional manner. As such, the cheese slices disposed with the package are imparted with the flavor disposed on the interleaf paper, thereby providing a flavored cheese slice.

The sliced, flavored cheese products of the present invention are of high quality and will remain fresh both before and after the packaging is opened, requiring only refrigeration to keep them fresh over an extended time period. The shredded cheese product blends of the present invention are of comparable cost to conventional sliced, flavored cheese products to enhance their market appeal and to thereby afford them the broadest possible market. Finally, all of the aforesaid advantages and objectives of the sliced, flavored cheese products of the present invention are achieved without incurring any substantial relative disadvantage.

### DESCRIPTION OF THE DRAWING

These and other advantages of the present invention are best understood with reference to the drawing, in which:

FIG. 1 is a perspective view of a plurality of cheese slices, formed into a stack of cheese slices, with each slice being separated by a sheet of interleaf paper having a flavor coating applied thereto;

FIG. 2 is a cross section of the stack of cheese slices illustrated in FIG. 1 which is taken along the line 2-2.

FIG. 3 is a side view of a sheet of interleaf paper having a flavoring component applied to the top surface thereof;

FIG. 4a is a side view of a sheet of interleaf paper having a flavoring component applied to the bottom surface thereof;

FIG. 4b is a side view of a sheet of interleaf paper having a flavoring component applied to both the top and bottom surfaces thereof;

FIG. 5 is a side view of a stack of cheese slices having a flavored interleaf paper disposed in between each slice, wherein the stack is disposed within a package;

FIG. 6 is a perspective view of a plurality of cheese slices, formed into a stack of cheese slices arranged in a shingled manner, with each slice being separated by a sheet of interleaf paper having a flavor coating applied thereto; and

FIG. 7 is a schematic flow diagram which shows a method for the manufacture of flavored cheese slices according to the teachings of the present invention.

### DETAILED DESCRIPTION OF THE PREFERRED EMBODIMENT

Although the disclosure hereof is detailed and exact to enable those skilled in the art to practice the invention, the embodiments herein disclosed merely exemplify the invention which may be embodied in other specific structures. In particular, the cheese slices of the present invention may be provided in any shape and size, and in any form of consumer, retail and/or commercial cheese packaging that is typically used to store and package cheese slices. Accordingly, while the preferred embodiment has been described, the details may be changed without departing from the invention, which is defined by the claims.

Preferably, the cheese used in the present invention is a natural cheese, such as provolone or mozzarella. However, any variety of soft, semi-hard or hard natural cheeses can be used with good effect. For example, cheddar, Swiss, Monterrey Jack, Asiago, Colby, blue, and Colby-Jack cheeses can all be sliced and used as the base for the flavored cheese slices and methods of the present invention. In addition, processed, imitation cheeses and vegan cheeses can also be used as the base for the flavored cheese product of the present invention, so the term “cheese” as used herein should be broadly interpreted to include such products. In particular, the present invention is applicable to cheeses having a variety of different fat contents, textures, porosities, etc., depending on desired consumer or market demands.

As will be appreciated by one skilled in the art, and as described in more detail below, the present invention is directed to cheeses produced by a variety of curing, aging and/or production methods. Further, the cheese can be cut and trimmed into slices by any means known to those skilled in the art, including those as described in more detail in U.S. patent application Ser. No. 10/857,098 entitled “Method and Apparatus for Slicing Small Cheese Portions and Preparing Cheese Loaves for Slicing,” which patent is hereby incorporated herein by reference.

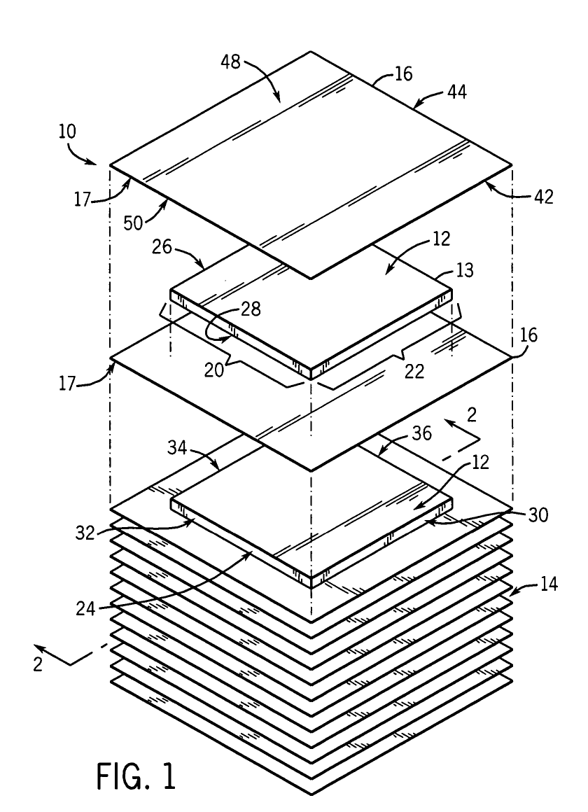

Turning now to FIG. 1, a sliced, flavored, cheese product, indicated generally at 10, is illustrated. The flavored cheese product 10 includes a plurality of individual slices 12 of cheese 13, arranged in a pile or stack of cheese slices, indicated generally at 14. Preferably, the stack 14 is arranged in a layered, overlapping manner, with each slice 12 of cheese 13 in the stack 14 being separated from one another by a sheet 16 of interleaf paper and/or barrier material 17. As illustrated in FIG. 6, the stack 14 may alternatively be arranged in a shingled manner or in a substantially overlapping arrangement, as required by the specific retail package or end-use application of the product.

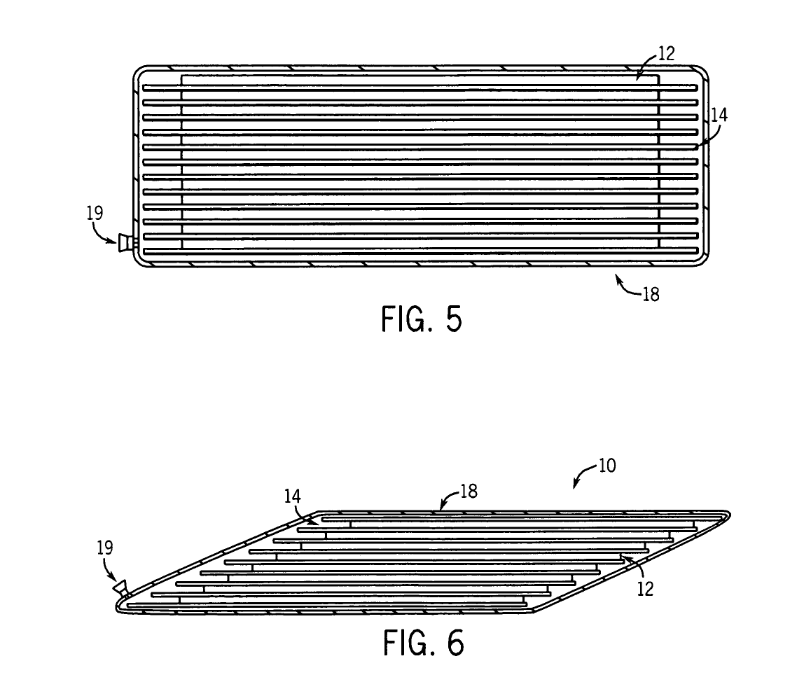

Turning for the moment to FIG. 5, and as will be described in more detail herein, the stack 14 can be disposed within any type of enclosure or packaging, such as a resealable thermoplastic or film bag 18 having a zipper or other resealable opening 19, and/or disposed on a tray or platter (not shown), or within any type of packaging known to those skilled in the art. In addition, the stack 14 may contain any number of cheese slices 12, depending on the type of consumer, commercial or retail packaging requirements and/or market demand.

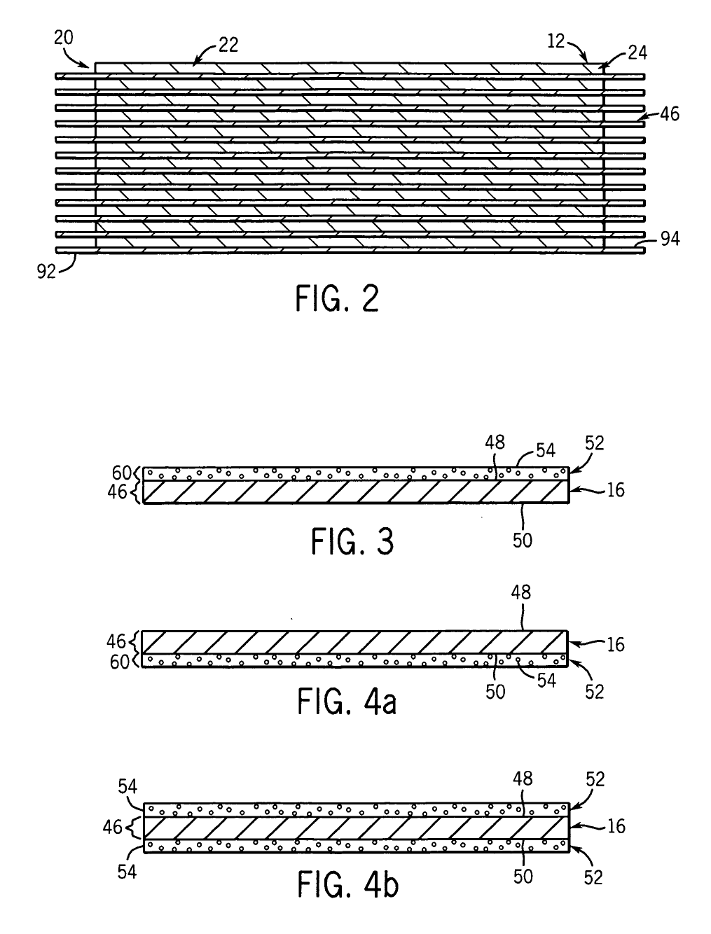

Referring again to FIGS. 1 and 2, each slice 12 of cheese 13 is preferably square in shape, having a length dimension 20, a width dimension 22 and a thickness 24. Each slice 12 is substantially flat having a top and bottom surfaces 26 and 28, and edges, 30, 32, 34, and 36, as illustrated in FIG. 1. As will be appreciated by those skilled in the art, consistent with the broader aspects of the present invention, the slices 12 may be of any shape known to those skilled in the art, such as rectangular, oval or circular, depending on the type of cheese or desired end-use packaging or food application.

Preferably, each slice 12 of cheese 13 is about three and one-half inches by about three and one-half inches and has a thickness 24 of about one-sixteenth of an inch. However, each of the slices 12 may have a length dimension 20 of up to about twelve inches and a width dimension 22 of up to about six inches, depending on the type of cheese to be flavored and/or the specific end-use for the product (i.e. consumer versus restaurant or deli, other commercial food service applications).

In addition, as will also be described in more detail herein, the thickness 24 of each of the slices 12 can range from about one thirty-second of an inch to about one-eighth of an inch, however, slices having a smaller or larger thickness 24 are also contemplated by the present invention. As will be readily recognized, each slice 12 in the stack 14 has substantially the same length dimension 20, width dimension 22 and thickness 24. However, where required, it is contemplated that the slices 12 in the stack 14 may vary in length dimension 20, width dimension 22 and/or thickness 24 within the stack 14.

Each sheet 16 of interleaf paper in the stack 14 is preferably square in overall shape, having a length dimension 42, a width dimension 44 and a thickness 46 and also having a top surface 48 and a bottom surface 50. As best illustrated in FIGS. 1 and 2, each sheet 16 is slightly larger in size than each of the cheese slices 12. In particular, if the cheese slices 12 are about three and one-half inches by about three and one-half inches in dimension, the sheet 16 can be about four inches by about four inches.

However, as will be appreciated by those skilled in the art, the sheets 16 can be any size and shape known to those skilled in the art and are preferably sized to correspond with the size and shape of each slice 12 of cheese 13, whereby each sheet 16 is slightly larger than each slice 12 of cheese. Further, the sheets 16 may be of different sizes, where required, for example, the bottom sheet or the top sheet in the stack 14 of the flavored, sliced cheese product 10 of the present invention may be larger than the remaining sheets.

Each sheet 16 of interleaf paper and/or barrier material 17 is preferably constructed of a paper, paperboard or cellulose-based interleaf material, as will be well known to those skilled in the art. In addition, the barrier material may be any material known to those skilled in the art that is considered safe or traditionally used in direct food contact applications and/or approved for use in direct food contact applications by the Food and Drug Administration, such as thermoplastic films, etc.

Turning now to FIG. 3, each sheet 16 of interleaf paper is coated with a film or layer 52 of a flavoring component 54 of substantially uniform thickness 60. The layer 52 is preferably disposed on the top surface 48 of the sheet 16, as illustrated in FIG. 3, however, each sheet 16 can be coated on the bottom surface 50, as illustrated in FIG. 4a, or both the top and bottom surfaces 48, 50, as illustrated in FIG. 4b, depending on the type of flavoring component 54, desired flavor intensity to be imparted to the cheese 13, the type of cheese 13, and/or required packaging arrangement, as will be described in more detail herein.

The flavoring component 54 is preferably a smoke flavor component, such as the type sold under the registered trademark CHARSOL®, including, for example, CHARSOL® C-10 by Red Arrow Products Co. LLC. or its licensees. As will be appreciated by those skilled in the art, the flavoring component 54 may be any flavor known to those skilled in the art, including, but not limited to, garlic, onion, chives, spices, herbs, such as dill, oregano, mint, parsley or basil, barbeque, bacon, alcohol (brandy, wine, etc.), fruit, such as strawberry or blueberry, vegetable flavors, such as tomato, mushroom or pepper, and/or flavors, such as vanilla, bubblegum and/or chocolate, with imagination being the only limitation. As will also be readily apparent, a combination of flavoring components 54 may be contained within the layer 52.

Consistent with the broader aspects of the present invention, the flavoring component 54 and/or the layer 52 thereof may also include a number of other food additives, as will be well known to those skilled in the art, such as preservatives, gums, anticaking agents, oxygen scavengers and/or taste enhancers. The sheet 16 may also be coated with substances meant for indirect food enhancers such as a wax or polymeric coating to assist in the separation of cheese slice 12 from the sheet 16 during dispensation of the cheese.

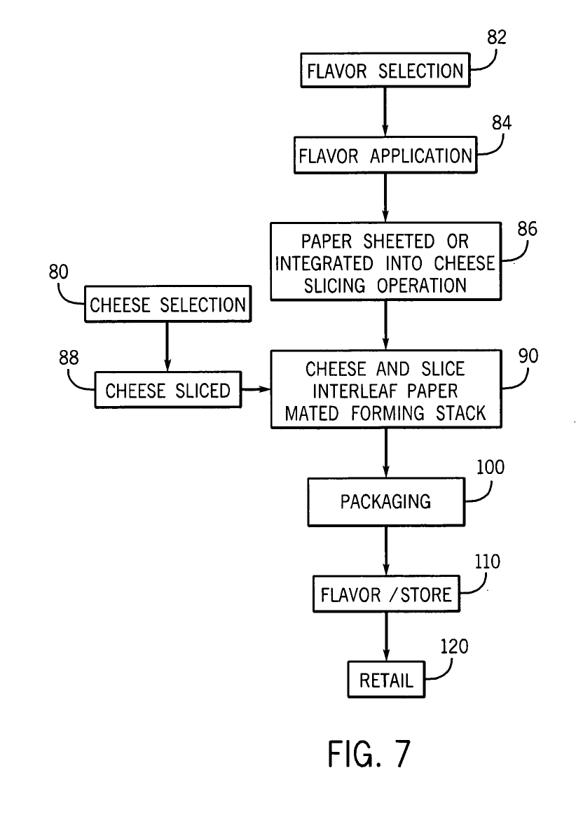

Turning next to FIG. 7, and with reference to FIGS. 1 through 4, a method of flavoring cheese of the present invention is now described. In particular, in a cheese selection step 80, the type of cheese 13, fat content and related composition of the cheese 13 and the length 20, width 22 and thickness 24 of the cheese slice 12 is determined.

In a flavor selection step 82, the flavoring component 54, preferably the smoke flavoring CHARSOL® C-10, is selected for use in the method of the present invention. As will be recognized by those skilled in the art, the particular composition of the flavoring component 54 will be selected based on the type of cheese 13 to be flavored, its fat and moisture composition, the size and thickness of the slice 12 to be flavored and the desired intensity of the flavor imparted thereto. As will also be recognized by those skilled in the art, the flavoring component 54 can be any one or more of those described herein, or any natural or synthetic food flavorings known to those skilled in the art.

In a flavor application step 84, the layer 52 of flavoring component 54 is applied to the interleaf paper/barrier material 17. The thickness 60 of the layer 52 of the flavoring component 54, and/or the concentration of the flavoring component applied to the sheet 16 will depend on the specific composition and physical properties of the flavoring component 54, the intensity of the flavor and/or color desired to be imparted to the cheese, the type of cheese, the fat content of the cheese and/or the thickness of the cheese slices. For example, the thickness 60 of the layer 52 of flavoring component can be larger, and/or more concentrated if a thicker cheese slice is to be flavored by the method of the present invention.

As a further example, and as will be readily appreciated by those skilled in the art, the thickness 60 of the layer 52 of flavoring component 54 can be adjusted depending on the fat content of the cheese 13 and the desired flavor intensity. In particular, a fat component, specifically milk fat, has an affinity to pick up flavors from other compounds it comes in contact with. As such, the thickness 60 of the layer 52 of flavoring component 54 and/or the concentration thereof can be increased or decreased depending on the fat composition of the cheese and/or type of flavoring component, such that the flavoring component 54 is applied to the sheet in an amount sufficient to impart the desired flavor intensity and/or other organoleptic properties to the cheese slice.

Preferably, the top surface 48 of the sheet 16 is coated with the flavoring component 54. However, the bottom surface 50 or both the top and bottom surfaces 48, 50 can be coated with the flavoring component 54, again, depending on specific composition and physical properties of the flavoring component, the type of cheese, the fat content of the cheese, the thickness of the cheese slices, the intensity of the flavor desired to be imparted thereto and/or the specific packaging arrangement for the final flavored cheese product. For example, if a thick or dense cheese slice is to be flavored by the method of the present invention, both the top and bottom surfaces 48, 50 of the sheet 16 of interleaf paper 17 can be coated with a flavoring component.

The flavoring component 54 may be applied to the interleaf paper material 17 and/or the sheets 16 of interleaf paper by spraying, painting, rolling the flavoring component 54 on to the desired surface of the interleaf paper/barrier material and/or treating one or both of the surfaces 48, 50 of the paper with the flavoring component 54 in any manner known to those skilled in the art for coating such interleaf paper and/or barrier materials. The flavoring component 54 is preferably allowed to dry prior to mating the interleaf paper material 17 and/or the sheets 16 with the cheese slices 12.

As will be well known to those skilled in the art, the barrier material 17 forming each of the sheets 16 can be provided with the desired flavoring component 54 before or after being sheeted into individual sheets 16, as required by a given production line and/or operational equipment.

In a interleaf paper integration step 86, a roll of coated paper and/or barrier material 17 or pre-cut sheets 16 thereof are supplied to the conventional slicing and/or packaging operation in the manner that an uncoated/unflavored barrier material 17 would be supplied to such operation, as will be well known to those skilled in the art.

In a cheese slicing step 88, the cheese selected in step 80 is sliced via conventional slicing operations prior to contact and/or flavoring using the flavored interleaf paper 17. Importantly, and as will be appreciated by those skilled in the art, the present invention provides a method for flavoring cheese after the cheese slices 12 have been formed or cut, leaving the “trim” cheese or remaining cheese unflavored, and therefore, easily utilized in other applications, such as in processed cheese or as an ingredient in another food product. Accordingly, the present invention provides flavored cheese, and in particular, smoked cheese slices flavored after cutting and slicing, rendering the trim cheese more valuable for sale or further production.

In a mating step 90, the cheese slices 12 are mated with the sheets 16 of flavored interleaf paper forming the stack 14 of cheese slices 12. In particular, and turning back for the moment to FIGS. 1 and 2, the stack 14 of the sliced, flavored cheese product 10 of the present invention is preferably assembled by providing a bottom sheet 92 of interleaf paper, with a layer 52 of flavoring component applied to the top surface 48 thereof, and placing a bottom cheese slice 94 directly on top of the bottom sheet 92 such that substantially the entire surface area 94 of the cheese slice 94 contacts the layer 52 of flavoring component 54 applied to the top surface 48 of the sheet 92. As will be recognized by those skilled in the art, the bottom surface 28 of the cheese slice 94 should preferably completely contact the layer 52 of flavoring component 54 to ensure uniform flavoring of the cheese slice 12.

The mating step 90 continues with a sheet 16, having a layer 52 of flavoring component applied to the top surface 48 thereof, being placed in an overlapping manner on the top surface 26 of the bottom cheese slice 94, such that the bottom surface 50 of the sheet 16 is in contact with the top surface 26 of the cheese slice 94.

Accordingly, the mating step 90 continues by alternating a sheet 16 of flavored interleaf paper with a slice 12 of cheese, such that each slice 12 of cheese is separated by a sheet 16 of interleaf paper, in a manner as described above. In particular, and as recited with reference to FIGS. 1 and 2, the sheets 16 of flavored interleaf paper are slightly larger in length dimension 42 and width dimension 44 than each of the cheese slices 12, such that substantially the entire surface area of the bottom surface 28 of each slice 12 is in contact with the layer 52 of flavoring component 54 disposed on the top surface 48 of each sheet 16 of interleaf paper. The mating step continues until the stack 14 of cheese slices contains the desired number of cheese slices, with a top sheet 98 of interleaf paper preferably positioned on the top of the stack 14.

In a packaging step 100, the stack 14 of cheese slices is enclosed within a bag or package 18, or otherwise overwrapped with a plastic film as will be well known to those skilled in the art. As such, the package 18 can be constructed of a thermoplastic film material, having the physical properties (i.e. porosity, permeability and composition) appropriate for storing and retailing the stack 14 of cheese slices—as will be well known to those skilled in the art of cheese packaging.

In a flavoring/storing step 110, the package 18 of cheese slices is stored at a temperature and humidity level appropriate for the particular cheese 113 to be flavored by the methods of the present invention, as will be well known by those skilled in the art and/or determined by application food safety and storing requirements.

Without limitation to any particular theory or mode of operation, during storage of the cheese slices 12, the flavoring component 54 disposed on the surface of the sheet 16 of interleaf material is absorbed, at least in part, by at least the fat component of the cheese 13. Indeed, and without limitation, the flavoring component 54 migrates and/or is otherwise imparted to the cheese slice 12, by virtue of the direct contact of the layer 52 of flavoring component 54 on the sheet 16 with the surface of the cheese slice 12, thereby forming flavored cheese slices 102 of the present invention. As such, even reduced fat or fat free cheese slices can be used with good effect in the methods of flavoring cheese of the present invention.

The flavoring step 110 continues until a desired flavor intensity is imparted to the cheese and/or until the cheese acquires a specified flavor concentration level. Flavor is imparted to the cheese is about one day, with the flavor intensifying during the storage period. Such storage time is typically up to about ten days to about two weeks, depending on the type, size and composition of the cheese slice, and the type, composition and thickness of the flavoring component 54 provided on the sheet 16 of interleaf paper in contact therewith. Importantly, the flavoring component 54 within the layer 52 is provided in an amount sufficient to impart the desired flavor intensity to the cheese over a reasonable period of storing and/or curing time.

In addition, the flavoring component 54 is provided in an amount sufficient to supply the cheese slice 12 with a given flavor intensity and/or flavoring component concentration within the cheese—in a specified time period in which after such specified time period, the intensity of flavor and/or concentration of flavoring component remains substantially constant and/or achieves a maximum level in such specified time period. In this manner, the flavor and/or intensity of the cheese slices does not change and/or the flavor does not substantially increase during each day the cheese slices remain in contact with the sheet of paper.

It is also during the flavoring step 110 in which the cheese can be imparted with a color by virtue of its contact with the layer 52 of flavoring component 54 disposed on the top surface 48 of each sheet 16 of interleaf paper. For example, where the flavoring component is a smoke flavor, a smoke color is also imparted to each of the cheese slices 102 during the flavoring step 110.

Finally, in a retail step 120, the packages of slices, flavored cheese product 10 are transported to the distributor and/or consumer retailer.

As will be recognized by those skilled in the art, the present invention is applicable to flavoring food products other than cheese. For example, any product, such as breads, crackers, deli meats or any other food stuff that can be sliced and/or packaged using an interleaf paper can be flavored using the methods of the present invention. In particular, such methods can include sandwiching or otherwise interposing a sheet of interleaf paper or barrier material, containing one or more flavoring components applied thereto, between slices of a food product and/or relatively thin foodstuffs and packaging the food stuff in a conventional manner.

### EXAMPLES OF THE INVENTION

The following non-limiting examples and data illustrate various aspects and features relating to the compositions and methods of this invention. Such aspects and features include the surprising and unexpected results obtained using a flavored interleaf paper material to flavor cheese, in particular, to add smoke flavor to natural cheese, having an appearance, aroma and taste characteristics substantially similar to that of cheese smoke by traditional methods. It should, of course, be understood that these examples are included for illustrative purpose only and that the invention is not limited to the particular combinations of cheeses, flavors, properties or the like set forth herein. Comparable utility and advantages can be realized using various other methodologies and/or compositional embodiments consistent with the scope of this invention.

All components and/or ingredients used in conjunction with the present invention are commercially available from sources well-known to those skilled in the art. Likewise, the various process parameters described herein can be readily modified by such individuals to account for variations in the identity or concentration of the cheese, flavoring and/or paper components and other ingredients as required to achieve results in accordance with those described herein.

### Example 1

A sample of the smoke flavor, CHARSOL® AB by Red Arrow Products Co. LLC, was painted directly onto a number of samples of cheese interleaf paper. (Cheese interleaf paper is used to prevent cheese slices from sticking together.) Each piece of paper measured about four inches by about four inches and the paper was painted on both sides with the CHARSOL® AB solution and allowed to dry at room temperature. A piece of this paper was then placed between each of 11 slices of cheese each of which measured approximately about three and one-half inches by about three and one-half inches and was about one-sixteenth of an inch thick. The stack of cheese was then packaged in a cheese bag with a twenty percent carbon dioxide and eighty percent nitrogen mix and was then held at forty degrees Fahrenheit for two weeks.

After two week the cheese was subjected to organoleptic examination and was found to contain a distinct smoke flavor. One of the additional benefits of this technique was found to be a slight darkening of the cheese where it came in contact with the paper. When cheese is smoked naturally in a smoke house the outside of the cheese darkens to a pale brown color. A similar color is produced on the cheese when it comes in contact with the smoked paper. This does not happen when artificial smoke flavor is added directly to cheese curd. As such the present invention provides a method of flavoring cheese, wherein the resulting smoked cheese sliced has the appearance, taste and aroma of cheese smoked by traditional smoking methods.

### Example 2

The smoke flavor, CHARSOL® 10 by Red Arrow Products Co. LLC, was applied directly onto one surface of cheese interleaf paper measuring about four inches by about four inches and allowed to dry at room temperature. A piece of this paper was then placed between a plurality of cheese slices, each of which measured approximately about three and one-half inches by about three and one-half inches and was about one-sixteenth of an inch thick. The stack of cheese was then packaged in a cheese bag with a twenty percent carbon dioxide and eight percent nitrogen mix and was then held at forty degrees Fahrenheit for two weeks.

After two weeks, the cheese had a distinct smoke flavor that did not get any stronger over the period suggesting substantially all of the smoke flavoring on the paper transferred and/or absorbed into the cheese slice.

One of the additional benefits of this technique was found to be a slight darkening of the cheese where it came in contact with the paper. When cheese is smoked naturally in a smoke house the outside of the cheese darkens to a pale brown color. A similar color is produced on the cheese when it comes in contact with the smoked paper. This does not happen when artificial smoke flavor is added directly to cheese curd. As such the present invention provides a method of flavoring cheese, wherein the resulting smoked cheese sliced has the appearance, taste and aroma of cheese smoked by traditional smoking methods.

It may therefore be seen that the present invention teaches one or more smoked cheese products, wherein cheese slices are flavored, within the consumer package using an interleaf paper or barrier material having smoke flavoring applied to one or more surfaces thereof. In particular, the present invention provides a smoked cheese product that is imparted with a smoke flavoring after trimming and slicing of the bulk cheese product, rendering the trim cheese unflavored/unsmoked and more valuable for resale. The present invention also provides a variety of smoked cheese products having the taste, appearance and aroma of cheese smoked by traditional methods and a method of imparting a smoke flavor to cheese slices that does not require the time, expense and labor of traditional smoking methods.

The present invention also teaches a flavored cheese product, provided in convenient individual slices, separated by a flavor-coated interleaf paper, wherein the interleaf paper is used not only for flavoring the cheese within the consumer package but also for facilitating removal of the cheese from the package or stack of cheese after purchase.

As such, the present invention also teaches one or more methods of flavoring a cheese product including separating each cheese slice in a stack of cheese slices with an interleaf paper or barrier material coated with at least one flavoring component, such that at least one of the surfaces of each slice of cheese is in contact with the flavoring component, and packaging the cheese slices in a conventional manner. As such, the cheese slices disposed with the package are imparted with the flavor disposed on the interleaf paper, thereby providing a flavored cheese slice.

The flavored cheese slices of the present invention present multiple applications to consumers so that each flavored cheese product has multiple potential uses in different applications. The flavored cheese slices of the present invention also contemplate different flavor variations, including both different cheeses, combinations of cheeses and/or different flavors or combinations of flavors provided within a single consumer package.

The flavored cheese slices of the present invention are of high quality and will remain fresh both before and after the packaging is opened, requiring only refrigeration to keep them fresh over an extended time period. The flavored cheese slices of the present invention are of comparable cost to conventional cheese slices to enhance their market appeal and to thereby afford them the broadest possible market. Finally, all of the aforesaid advantages and objectives of the flavored cheese slices of the present invention are achieved without incurring any substantial relative disadvantage.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A smoked cheese product comprising:
a first sheet of interleaf material having a first surface and a second surface;
a first layer of a smoke flavoring component applied to the first surface of the sheet, the layer of smoke flavoring component having a thickness; and
a first slice of cheese having a first surface overlying and in direct contact with the layer of smoke flavoring on the first surface of the sheet, the slice of cheese also having a second surface, wherein the sheet of interleaf material, the layer of smoke flavoring component and the slice of cheese are disposed within an enclosure.

2. The smoked cheese product as defined in claim 1, wherein the sheet of interleaf material is constructed of paper, plastics or foil.

3. The smoked cheese product as defined in claim 1, wherein the slice of cheese is selected from the group consisting of provolone, mozzarella, cheddar, Swiss, Monterrey Jack, Asiago, Colby, blue, Colby-Jack and combinations thereof.

4. The smoked cheese product as defined in claim 1, wherein the slice of cheese is processed cheese.

5. The smoked cheese product as defined in claim 1, wherein the slice of cheese is formed in the shape of a square, a rectangle, a circle, or an oval.

6. The smoked cheese product as defined in claim 1, wherein the slice of cheese has a length dimension, a width dimension, and a thickness and wherein the sheet of interleaf material has a length dimension larger than the length dimension of the slice of cheese and a width dimension larger than the width dimension of the slice of cheese.

7. The smoked cheese product as defined in claim 6, wherein the length dimension is the slice is up to about six inches, the width dimension of the slice is up to about six inches.

8. The smoked cheese product as defined in claim 6, wherein the thickness of the cheese slice ranges from about one-thirty-second of an inch to about one-eighth of an inch.

9. The smoked cheese product as defined in claim 6, wherein the thickness of the layer of smoke flavoring component applied to the interleaf material is proportional to the thickness of the cheese slice.

10. The smoked cheese product as defined in claim 1, wherein the enclosure is a resealable bag.

11. The smoked cheese product as defined in claim 1, further comprising:
a second sheet of interleaf material having a first surface and a second surface, the second surface of the second sheet overlying and in direct contact with the second surface of the first slice of cheese;
a second layer of a smoke flavoring component applied to the first surface of the second sheet; and
a second slice of cheese having a first surface overlying and in direct contact with the second layer of smoke flavoring on the first surface of the second sheet, the second slice of cheese also having a second surface, wherein the first sheet, the first layer, the first slice of cheese, the second sheet, the second layer and the second slice form a stack and wherein the stack is disposed within the enclosure.

12. A sliced, flavored cheese product comprising:
a plurality of slices of cheese forming a stack of cheese slices, each of the cheese slices in the stack of cheese slices having a first surface and a second surface;
a plurality of sheets of interleaf material, each of said sheets of interleaf material having a first surface coated with a flavoring component and a second surface, wherein the stack of cheese slices is arranged such that each of the cheese slices is separated from every other cheese slice by one of the plurality of sheets of interleaf material and wherein one of the first and second surfaces of each of the slices of cheese overlies and directly contacts the first surface of the one sheet of interleaf material; and wherein the stack of cheese slices is placed in a package.

13. The sliced, flavored cheese product as defined in claim 12, wherein the plurality of slices of cheese in the stack is selected from the group consisting of provolone, mozzarella, cheddar, Swiss, Monterrey Jack, Asiago, Colby, blue, Colby-Jack, and combinations thereof.

14. The sliced, flavored cheese product as defined in claim 12, wherein the plurality of slices of cheese in the stack is a processed cheese product.

15. The sliced, flavored cheese product as defined in claim 12, wherein each sheet of interleaf material is constructed of paper.

16. The sliced, flavored cheese product as defined in claim 12, wherein the second surface of each sheet of interleaf material is coated with a flavoring component.

17. The sliced, flavored cheese product as defined in claim 12, wherein the flavoring component is a smoke flavor.

18. The sliced, flavored cheese product as defined in claim 12, wherein the flavoring component is selected from the group consisting of garlic, onion, chives, spices, herbs, barbeque, bacon, alcohol, fruit, vegetable, vanilla, bubblegum, chocolate, and combinations thereof.

19. The sliced, flavored cheese product as defined in claim 12, wherein the flavoring component comprises a food additives selected from preservatives, gums, anti-caking agents, taste enhancers, oxygen scavengers and combinations thereof.

20. The sliced, flavored cheese product as defined in claim 12, wherein the stack of cheese slices includes slices of cheese formed in the shape of squares, rectangles, circles, ovals and combinations thereof.

21. The sliced, flavored cheese product as defined in claim 12, wherein the each of the slices of cheese in the stack of cheese slices has a length dimension, a width dimension and a thickness and wherein the sheet of interleaf material has a length dimension larger than the length dimension of the slice of cheese and a width dimension larger than the width dimension of the slice of cheese.

22. The smoked cheese product as defined in claim 20, wherein the length dimension is the slice is up to about six inches, the width dimension of the slice is up to about six 6 inches.

23. The sliced, flavored cheese product as defined in claim 20, wherein the thickness of each of the cheese slices ranges from about one-thirty-second of an inch to about one-eighth of an inch.

24. A method of flavoring cheese to a specified flavor level, the method comprising:
providing a slice of cheese having a first surface, a second surface;
providing a sheet of interleaf material having a first and a second surface;
applying a layer of flavoring coating to one of the first and second surfaces of the interleaf material;
placing the first surface of the cheese slice in direct contact with the layer of flavoring coating applied to the one of the first and second surfaces of the interleaf material, wherein substantially the entire surface area of the first surface of the cheese slice is in direct contact with the layer of flavoring coating; and
storing the slice of cheese and flavored interleaf paper in an enclosure until the specified flavor level is achieved in the slice of cheese.

25. The method of flavoring cheese of claim 24, wherein the layer of flavoring component is applied by one of spraying, painting, or rolling the flavoring component onto the interleaf material and wherein the flavoring component is dried before placing the first surface of the cheese slice in direct contact with the layer of flavoring coating.

26. The method of flavoring cheese of claim 24, wherein a layer of flavoring coating is applied to both the first and second surfaces of the interleaf material.

27. A method of producing a smoked cheese product, the method comprising:
providing a plurality of cheese slices, each of the cheese slices having a first surface and a second surface;
providing a plurality of sheets of interleaf material, each sheet having a first and a second surface;
coating at least one of the first and second surfaces of each sheet of interleaf material with a layer of smoke flavoring;
arranging the plurality of cheese slices and the plurality of coated sheets of interleaf paper in a stack, whereby each cheese slice in the stack is separated by at least one of the sheets of coated interleaf material; and
storing the stack in a sealed enclosure.

28. The method of producing a smoked cheese product, wherein the stack is arranged by placing a sheet of coated interleaf material between each of the cheese slices in the stack of cheese slices, such that at least one of the first and second surfaces of each of the cheese slices is in complete and direct contact with the layer of smoke flavoring on the at least one first and second surface of the interleaf material.
